(19) United States
(12) Patent Application Publication
(10) Pub. No.: US 2025/0019118 A1
(43) Pub. Date: Jan. 16, 2025

(54) PLASTIC PALLET WITH IMPROVED JOINING SYSTEMS AND METHOD THEREOF

(71) Applicant: Plasticos Tecnicos Mexicanos, S.A. de C.V., San Juan del Río, Querétaro (MX)

(72) Inventors: Alejandro Gómez Caudillo, Querétaro (MX); Juan Pedro Baca Sánchez, Querétaro (MX); Andrea Jaramillo Lopez, Querétaro (MX); Adrián Andrade Ontiveros, Querétaro (MX)

(21) Appl. No.: 18/707,855

(22) PCT Filed: Jan. 12, 2023
(86) PCT No.: PCT/IB2023/050292

§ 371 Date: May 6, 2024

Related U.S. Application Data
(60) Provisional application No. 63/298,942, filed on Jan. 12, 2022.

(51) Int. Cl. B65D 19/00; B29C 65/58; B29C 65/60; B29C 65/72; B29L 31/00

(52) U.S. Cl. CPC B65D 19/0038; B29C 65/58; B29C 65/606; B29C 65/72; B29L 2031/7178; B65D 2519/00034; B65D 2519/00069; B65D 2519/00129; B65D 2519/00273; B65D 2519/00288; B65D 2519/00308; B65D 2519/00318; B65D 2519/00333; B65D 2519/00442; B65D 2519/00567

(57) ABSTRACT

The present disclosure relates to multi-piece plastic pallets with hot riveting joining systems.

### FIELD OF THE INVENTION

The field of the disclosure relates to plastic pallets or material handling platforms such as those utilized in the stacking, heavy loading, storing, and shipping of several articles and goods, as well as merchandise. More particularly, the present disclosure relates to multi-piece plastic pallets with an improved joining system which is based on hot riveting.

### CROSS REFERENCE TO RELATED APPLICATIONS

This application claims the benefit of the filing date of U.S. Provisional Application Ser. No. 63/298,942 filed on Jan. 12, 2022, under 35 U.S.C. 119 (e), the entire disclosures of which are incorporated by reference herein.

### BACKGROUND OF THE INVENTION

The snap-fit assembly method, included as an additional adjustment mean in the present invention, is a known mechanical joint involving two coupling components requiring that at least one of said components to be deformed to be hooked or matched one to the other. Based on the above, it is known that snap-fit assembly method presents undesired movement or a certain degrees of movement freedom once the assembly has been performed. This movement freedom of the joint represents an important disadvantage when applying loads on pallets since it accentuates the natural deformation of the pallet when it is handled with a forklift (namely, due to dynamic load) and when it is placed in racking condition, thus, snap-fit joints in pallets tend to fail under impacts and falls typical of the use or application.

Based on the above, it is needed to provide improved and enhanced adjustment and coupling means for a pallet, particularly, regarding the coupling between upper and bottom decks of a pallet, minimizing the deformations present during the loading conditions of the pallet and thus, enhancing the overall mechanical properties of the pallet.

### SUMMARY OF THE INVENTION

In accordance with the aspects and objects of the present disclosure, provided is a pallet made of thermoplastic material comprising a top deck and a bottom deck being connected by an improved mechanical joining system comprised in a plurality of spaced apart legs, being the legs integrally formed in both upper and/or bottom deck, respectively.

In one embodiment, the plurality of spaced apart legs comprises a first set of legs, disposed in each four corners respectively of both upper and bottom deck; a second set of legs, disposed centered in both sides ends respectively of both upper and bottom deck; a third set of legs, disposed in the middle in both front and rear ends respectively of both upper and bottom deck; and a fourth set of legs, disposed right in the centre respectively of both upper and bottom deck. In another embodiment, the pallet made of thermoplastic material comprises the bottom deck with skids or runners that can be arranged at the borders of the pallet in a cross-pattern shape or disposed parallel to each other or any other combination, and a top deck that can be smooth or closed, with some openings or a grid type pattern, joined by the system of the present disclosure, said system can be located inside the legs of the pallet. Each leg of the pallet includes a wall structure inside designed to absorb shocks from forklifts and pallet drops.

In one embodiment, the improved mechanical system disposed in each leg of the plurality of spaced apart legs comprises a plurality of joining members projecting from the upper deck, being the joining members, for example, pre-formed pins, rods, stakes and/or shanks. Said joining members are spaced apart from each other on the perimeter of the legs, and the number and array of the joining members may vary according to the set of legs.

Moreover, the improved mechanical system further comprises holes, located in the lower part of each leg of the plurality of spaced apart legs in the bottom deck of the pallet. Said holes are disposed or located based on the position or projection of the top deck joining members, in such a way that, said joining members are inserted into the holes. In this sense, the number and array of said holes are identical to the number and array of the joining members, thereby, the number and array of the holes vary according to the set of legs.

The joining of the top deck and the bottom deck shall be performed by hot riveting, heat stake riveting and/or hot air riveting of the pre-formed pins. Once the top deck joining members pass through the bottom deck holes, then a pin head is formed in the distal end of each pre-formed pins, producing a mechanical interference between the newly formed pin heads and the bottom portion of the bottom deck leg. In one aspect, once the pin head is formed, this will have the shape of a dome, plate, disk, semi-sphere, and related shapes.

One of the advantages of the improved joining system of the present disclosure is providing a plastic pallet with a form-fitting and non-detachable union, avoiding the disadvantages of the prior art, for instance, the struggle of controlling a hot plate welding process in combination with the molding deformations, as well as the handling residues generated in said process. Moreover, the joining system of the present disclosure avoids the related disadvantages of mechanical joints/assemblies, for instance, coupling using ONLY snap-fit joints.

The present disclosure further relates to a method for carrying the hot riveting of the pins, wherein a suitable heat source is applied for heating the thermoplastic material and forming the distal end of the joining members into the pin heads to produce mechanical interference between the newly formed pin heads and the bottom portion of the bottom deck leg, thus, performing the joining of the top deck and the bottom deck of the pallet.

These and other objectives will be apparent to the person skilled in the technical field to which the present disclosure pertains, based on the following detailed disclosure, the accompanying figures, as well as the appended claims.

### BRIEF DESCRIPTION OF THE DRAWINGS

Having described the disclosure in the above general terms, reference will now be made to the accompanying drawings showing representative embodiments of the present disclosure, where:

FIG. 1A is a perspective view according to the preferred embodiment of the pallet of the present disclosure.

FIG. 1B is a perspective view according to an additional embodiment of the pallet of the present disclosure.

FIG. 2A is an exploded-perspective view of the preferred embodiment of the pallet of the present disclosure, showing the top and bottom deck shown in FIG. 1A.

FIG. 2B is an exploded-perspective view of the additional embodiment of the pallet of the present disclosure, showing the top and bottom deck shown in FIG. 1B.

FIG. 3A is a perspective detailed view of a leg of the preferred embodiment of the pallet shown in FIG. 1A; showing a portion of the top deck leg (upper) and a portion of the bottom deck leg (lower) before coupling both decks.

FIG. 3B is a perspective detailed view of the leg of the preferred embodiment of the pallet shown in FIG. 3A, showing both upper and lower decks of the pallet fully coupled between each other, showing the improved mechanical system of the present disclosure before the hot riveting process.

FIG. 3C. is a bottom view of the leg of the pallet of the present disclosure, according to the preferred embodiment of the present invention, showing a portion of the improved mechanical system of the present disclosure, in this case, a plurality of joining members (4) (formed in the upper deck of the pallet) passing through a plurality of holes (comprised in the lower deck of the pallet), and showing interior and exterior walls (ii) within the legs as an enhanced impacts resistance structure.

FIG. 4A is a front cross-section view of the improved mechanical system of the pallet according to the preferred embodiment, showing on one hand, the snap fit coupling in an lower location array and on the other hand, the pre-formed rivet pin before the hot riveting process; additionally, FIG. 4 shows a first assembly step for the pallet of the present disclosure, being the snap fit component configured to avoid any undesired displacement of both upper/lower decks before or during the hot riveting process.

FIG. 4B is a front cross-section view of the improved mechanical system of the pallet according to an additional embodiment, showing on one hand, the snap fit coupling in an upper location array and on the other hand, the pre-formed rivet pin before the hot riveting process; additionally, FIG. 4B shows a first assembly step for the pallet of the present disclosure, being the snap fit component configured to avoid any undesired displacement of both upper/lower decks before or during the hot riveting process.

FIG. 5A is a front cross-section view of the improved mechanical system of the pallet according to the preferred embodiment shown in FIG. 4A, showing the rivet pins already deformed by the hot riveting process, namely, FIG. 5A shows the improved mechanical system after applying the hot riveting process and in a final configuration or assembly final configuration, wherein both snap-fit coupling and hot-riveted pins work jointly.

FIG. 5B is a front cross-section view of the improved mechanical system of the pallet according to the additional embodiment shown in FIG. 4B, showing the rivet pins already deformed by the hot riveting process, namely, FIG. 4A shows the improved mechanical system after applying the hot riveting process and in a final configuration or assembly final configuration, wherein both snap-fit coupling and hot-riveted pins work jointly.

FIG. 5C is a perspective cross-section view of the improved mechanical system of the pallet according to the preferred embodiment shown in FIG. 4A, showing the pre-formed rivet pin passing thought the holes of the lower deck and before the hot riveting process.

FIG. 5D is a perspective cross-section view of the improved mechanical system of the pallet according to the preferred embodiment shown in FIG. 5A, showing the rivet pins already deformed by the hot riveting process.

FIG. 5E is a front view of the pallet of the present disclosure according to the preferred embodiment shown in FIG. 1A, showing a peripheral grip (100), which improves the interaction between the pallet and a stretch film.

FIG. 6 is an upper cross-section view of the leg of the pallet of the present disclosure, according to the preferred embodiment shown in FIG. 1A, showing the interior and exterior walls (ii) (ribs array) within the legs which are depicted as an enhanced impacts resistance structure in the present invention.

FIG. 7 is a perspective view of an additional embodiment of the pallet of the present disclosure, showing a pallet with improved reinforcement metallic bars disposed next to (or above to) the snap-fit coupling of the improved mechanical system of the present invention.

FIG. 8 is a front view of the additional embodiment of the pallet of the present disclosure of FIG. 7, showing the improved reinforcement metallic bars disposed next to (or above to) the snap-fit coupling of the improved mechanical system of the present invention.

FIG. 9 is a representation of the racking and loading (dynamic) physical test performed and applied to the pallet of the present disclosure, using the configuration of the preferred embodiment of FIG. 1A, to obtain the results of the Examples of the present application.

FIGS. 10A and 10B are representative graphics of the pallet performance under the physical loading test (dynamic load), showing an advantageous decrease on instant and final deflection comparing using only snap fit coupling (previous art) and using the improved mechanical system, according to a preferred embodiment of the present invention.

FIG. 10C is a line graphic, representing the pallet performance during loading test (dynamic load), showing deflection, using only snap fits (previous art) and the advantageous decrease on deflection using the improved mechanical system, according to a referred embodiment of the present invention.

FIG. 10D are front views of the representation of the loading (dynamic) physical test performed and applied to the pallet of the present disclosure from FIG. 9, showing the pallets being mechanical tested for dynamic load test, only using snap fits (previous art) and using the improved mechanical system according to the preferred embodiments of the present invention.

FIGS. 11A and 11B are representative graphics of the pallet performance under the physical racking test, showing an advantageous decrease on instant and final (after 24 racking hours) deflection comparing using only snap fit coupling (previous art) and using the improved mechanical system, according to a preferred embodiment of the present invention.

FIG. 11C is a line graphic, representing the pallet performance during racking test, showing deflection, using only snap fits (previous art) and the advantageous decrease on deflection using the improved mechanical system, according to a referred embodiment of the present invention.

FIG. 11D are front views of the representation of the racking physical test performed and applied to the pallet of the present disclosure from FIG. 9, showing the pallets being mechanical tested for racking test, only using snap fits (previous art) and using the improved mechanical system according to the preferred embodiments of the present invention.

FIG. 12A to 12D are perspective views representing the FEA analysis results applied for the pallet of the present disclosure, using the configuration of the preferred embodiment shown in FIG. 1A.

### DETAILED DESCRIPTION OF THE INVENTION

Some aspects of the present disclosure will now be described in more detail with further reference to the accompanying drawings in which some, but not all, of the advantages of the present disclosure are shown. Indeed, various embodiments of the disclosure can be expressed in many different ways and should not be construed as being limited to the embodiments described herein. Rather, these exemplary embodiments are provided so that this disclosure will be comprehensive and complete, and will fully convey the scope of the disclosure to those skilled in the art. Furthermore, as used in the description and the appended claims, the singular forms “a,” “an,” and “the” are inclusive of their plural forms, unless the context clearly indicates otherwise.

Also, exemplary embodiments are provided so that this description is complete and exemplifies the scope to those skilled in the art. Numerous specific details, such as component examples, and specific methods, are set forth to provide a complete understanding of the embodiments of the present disclosure. It will also be apparent to those skilled in the art that no specific details are needed, that the exemplary embodiments can be realized in many different ways, and that they should not be construed as limiting the scope of the disclosure. In some exemplary embodiments, well-known processes, well-known device structures, and well-known technologies are not described in detail.

To solve the related prior-art disadvantages, the embodiments of the present disclosure relate to plastic pallets comprising a top deck and a bottom deck being joined by a mechanical system based on hot riveting of a pre-formed rivet pin integrally formed in the top deck leg, once said pre-formed rivet pin passes through a hole located in the bottom deck leg.

Thus, said mechanical system of the present invention may further comprise additionally adjustment means, wherein the combination of both hot rivet of a pre-formed rivet pin and said additional adjustment means (SF), allows to stiffen and stabilize the joint of the top deck with the bottom deck minimizing the deformations present during the loading conditions of the pallet, and consequently, enhancing the overall mechanical properties of the pallet. This advantageous and novel combination will be further described in detail within this application.

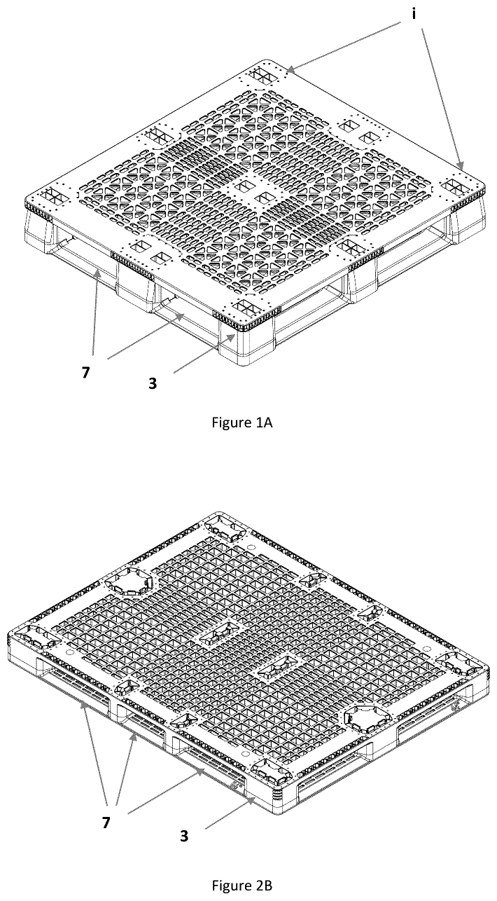

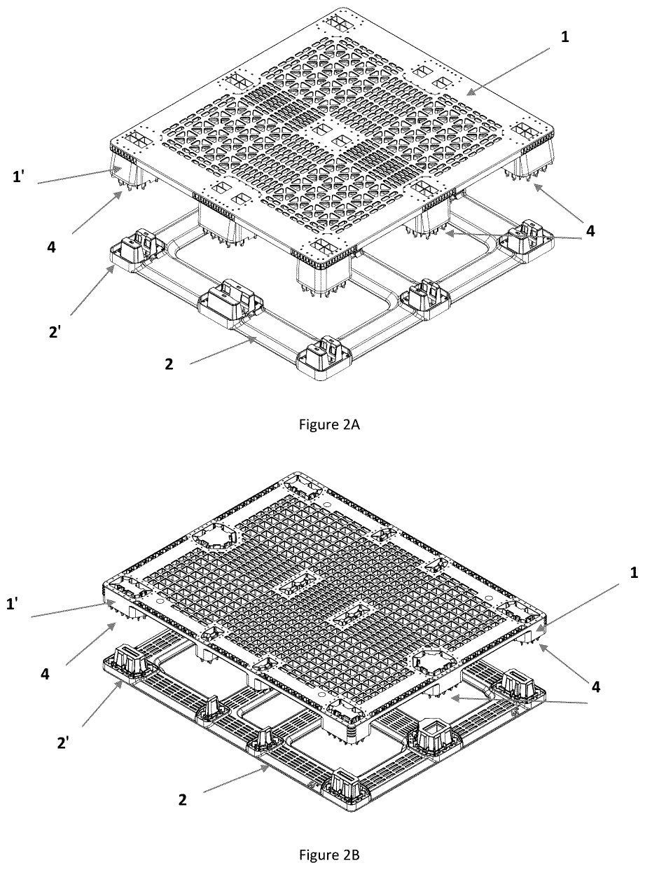

According to one embodiment shown in FIGS. 1A, 1B, 2A and 2B, the plastic pallet comprises a top deck (1), which is in turn formed by an upper face, a lower face, a left side face, a right-side face, a front face, and a rear face, wherein the lower face includes a plurality of legs (3) integrally formed thereof, and wherein said plurality of legs are at least one upper part of leg (1′), as well as a plurality of crossed and simple ribs.

The legs (3) may be embodied with different forms, dimensions and not necessarily be embodied as discloses or shown in the Figures.

A bottom deck (2), which is in turn formed by an upper face, a lower face, a left side face, a right-side face, a front face and a rear face, wherein the upper face includes a plurality of legs integrally formed thereof, and wherein said plurality of legs are at least one lower part of leg (2′), as well as a plurality of crossed ribs, a plurality of simple ribs and a plurality of fork entries (7).

It must be understood that the preferred embodiment of the pallet of the present disclosure is shown in FIGS. 1A and 2A; in this sense, FIGS. 1B and 2B are additional embodiments of the pallet comprising, for example, a different top deck or lower deck, different arrays of ribs, and different shapes and proportions; nevertheless, this additional embodiment is intended to show that the improved mechanical system of the present disclosure can be adapted to different pallets without stepping out of the scope and essence of the invention, being said innovative essence the implementation and combination of the two mechanical coupling systems of the improved mechanical system which will henceforth be fully described.

In an embodiment, the crossed ribs in the top deck coincide with the crossed ribs of the bottom deck to provide enhance resistance to bending when the top and bottom are joined. In another embodiment, the crossed ribs in the top deck do not necessarily coincide or match with said crossed ribs of the bottom deck.

The main function of the top deck (1) is providing a flat support surface for laying goods or merchandise in its upper part. It should be mentioned that, in the case that the upper face of the top deck (1) is manufactured in a flat solid plastic surface, this improves desirable hygienic conditions required in specific industries and appliances, for example, the pharmaceutical or food industry. Likewise, the upper part of the top deck (1) may comprise a plurality of anti-slip pads (i), enhancing stability and reducing sliding of the goods or merchandise placed thereof, so as racking of other pallets.

On the other hand, the bottom deck (2) is a plastic structure with hollow parts, which allow saving material for its manufacture and thus, reducing the overall weight of the pallet and the material required for its manufacture. Furthermore, the hollow parts of said bottom deck (2) allows water flowing from sprinklers activated by firefighting systems in warehouses.

The bottom deck (2) comprises solid parts that contribute to increase the overall mechanical strength of the pallet.

The upper part of said bottom deck (2), comprises a set of crossed ribs and simple ribs, which provide enhanced resistance to torsion and flexion to the pallet, in response to an external load placed on the upper portion of the top deck (1). Particularly, the array of said set of crossed ribs disposed in the upper part of the bottom deck (2) have a mirror design as to the crossed ribs of the lower part of the top deck (1) so that both top (1) and bottom (2) decks shall dock or attach in a coincident way in order to improve the mechanical properties of the assembly, in the same way as simple ribs in both top and bottom deck; in an additional embodiment, the array of said set of crossed ribs disposed in the upper part of the bottom deck (2) may not have a mirror design as to the crossed ribs of the lower part of the top deck (1), thus, the array of the set of crossed ribs may be different between each other.

According to the present disclosure, the joining or coupling between the lower face of the top deck (1) with the upper face of the bottom deck (2), may occur when the lower part of leg (2′) of the bottom deck (2) overlap with the upper part of leg (1′) of each leg of the plurality of legs, forming a plurality of spaced apart, entirely formed, legs (3) corresponding to each leg of the plurality of legs, as shown in FIGS. 1A, 1B and 2A, 2B.

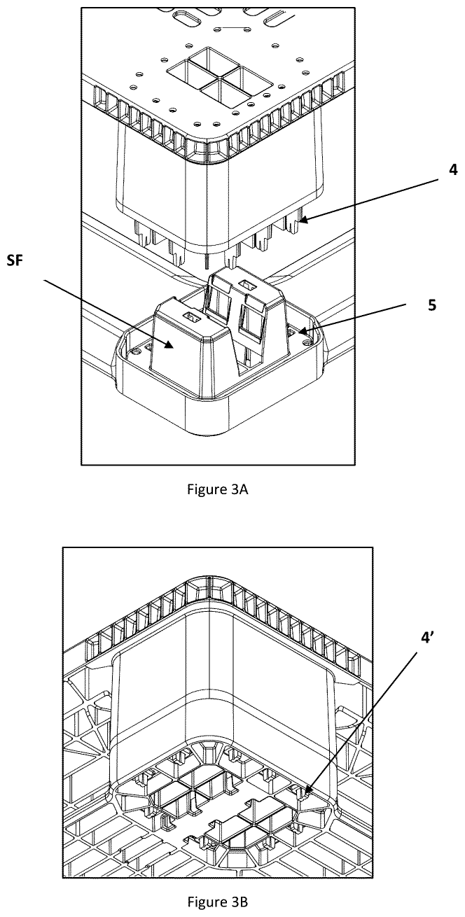

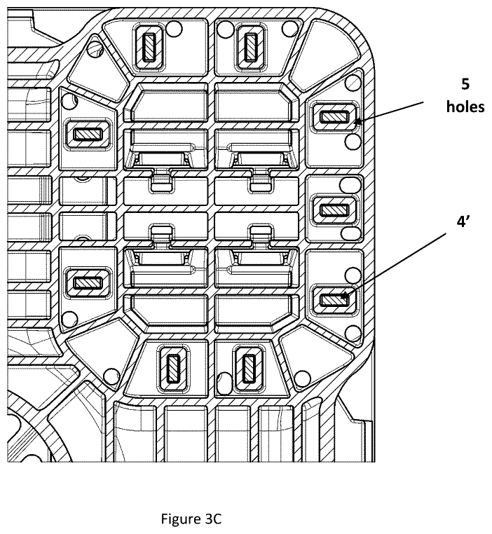

In other embodiments, the legs may be entirely formed in the top deck or the bottom deck, or any known combination. Therefore, the improved joining system of the present disclosure can be applied to any pallet or thermoplastic product involving any portion to be joined between its parts. Then, in one embodiment, when said upper (1) and bottom (2) deck are overlapped as previously referred, a plurality of joining members (4) integrally formed in the top deck (1) legs pass through a corresponding plurality of holes (5) disposed in the bottom deck (2) legs, as shown in FIGS. 3C, 4A, 4B, 5C and 5D.

In other embodiments, the plurality of joining members (4) can be formed in the bottom deck and the plurality of holes (5) in the top deck, or in or in an alternate arrangement, i.e., joining members and holes in both top and bottom deck.

The plurality of spaced apart, entirely formed legs comprises a first set of legs, disposed in each four corners respectively of both upper and bottom deck; a second set of legs, disposed in the centre in both sides ends respectively of both upper and bottom deck; a third set of legs, disposed in the middle in both front and rear ends respectively of both upper and bottom deck; and a fourth set of legs, disposed right in the centre respectively of both upper and bottom deck.

In another embodiment, the pallet made of thermoplastic material comprises the bottom deck with skids or runners that can be arranged at the borders of the pallet, in a cross pattern shape or disposed parallel to each other or any other combination thereof, and a top deck that can be smooth or closed, with some openings or a grid type pattern, joined by the system of the present disclosure, said system can be located inside the legs of the pallet. Each leg of the pallet includes a wall structure inside, designed to absorb shocks from forklifts/pallet drops.

Therefore, the joining members (4) are disposed or located in the periphery of each leg of the plurality of spaced apart legs, wherein the number and array of the joining members vary according to the set of legs, namely, the first set of legs have a first array of joining members which is different to a second, third and fourth array of joining members of the corresponding second, third and fourth set of legs; said vary of arrays of the joining members allow a simple and secure attachment between the top (1) and bottom (2) deck, as each set of legs have its corresponding joining members to which it will be coupled.

In one related aspect, each of the joining members (4) are separated by a predetermined distance, for example 25 mm or any required distance.

According to other aspect of the present disclosure, once the plurality of joining members (4) passes through the corresponding plurality of holes, the joining members comprise a distal end portion or pin head (4′) protruding from the lower portion of the holes as shown in FIGS. 3A, 3B, 4A, 4B, and 5C then, said distal end portion (4′) further may be formed in a hot riveting process as will be described in detail as follows.

As shown in FIG. 2, each upper part leg (1′) comprises in its periphery a plurality of joining members (4), wherein said joining members are made of the same material as the top and bottom deck of the pallet, e.g., HDPE or polypropylene. In an embodiment, the joining members are integrally formed with the top deck (1), and the material of which said joining members (4) are made of may be deformable by heat or may have adequate properties to allow the transformation throw heat deformation of the distal end portion (4′) of each joining members (4) during the hot riveting process. The joining members (4) are, for example, pre-formed pins, rods, stakes and/or shanks, or any suitable piece. In the context of the present disclosure, the joining member (4) can be referred to as pre-formed rivet pins with their respective holes (5).

The joining members (4) are inserted into the holes (5) located in the lower part of the leg (2′), that is, in the bottom deck of the pallet, as previously referred.

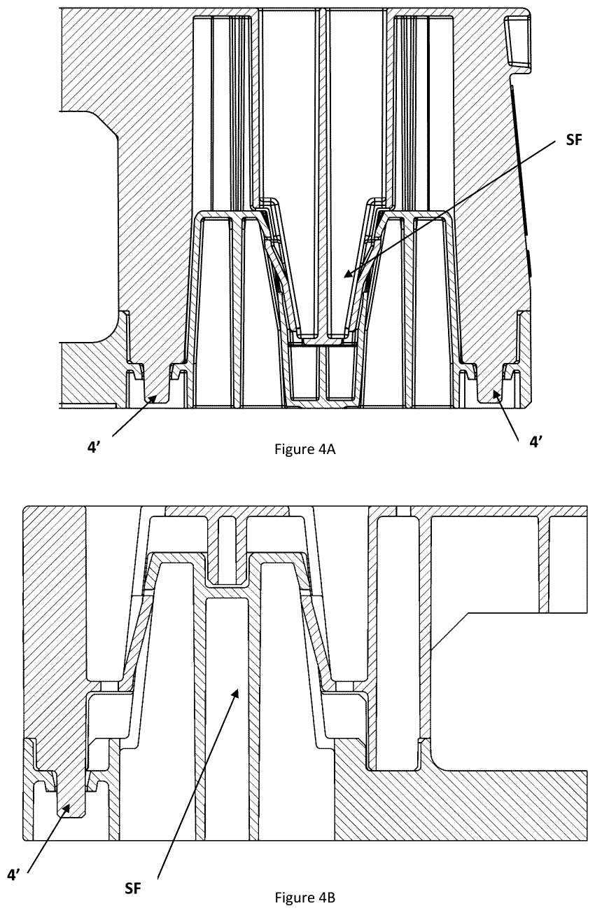

Accordingly, the joining members (4) exactly match in number and array with the holes (5) in the lower part of the leg (2′). Also, as previously referred, the joining members (4) have such a length that after the top deck and bottom deck are fully coupled, a distal end portion or pin head (4′) protrudes from the corresponding opposite portion, thus, said pin head (4′) shall be exposed to perform a hot riveting process herein. In other words, said pin head (4′) shall be heated to form a dome, plate, disk, semi-sphere, and related shapes. FIG. 4 shows a cross-section view of the joining system of the present disclosure in a pre-riveting position; the previously mentioned will be clearer referring to the accompanying FIGS. 3A, 3B, and 3C.

Said dome (6) may have many shapes, e.g. a plate, disk, semi-sphere or related shapes.

According to a further aspect, the present disclosure provides a method for carrying out the hot riveting process of the pin head (4′). The method comprises bringing the pin head (4′) to an optimum temperature, wherein the plastic material of said preformed rivet pins can be deformed; said optimum temperature is constantly applied by heat supply from an adequate heat source and forming a rivet head or a pin head with a die integrally formed with the heat source in a quickly and stably manner. In this sense, as soon as the pin head (4′) has reached the required temperature for modifying its form, a preset pressure is applied to said preformed rivet pin, until said pin head (4′) is modified producing a rivet head or a pin head (6). Finally, the joining system may be cooled down to preserve and strengthen the new formed rivet head (6).

In an embodiment, the heat source which applies constant heat to the preformed rivet pin, as previously disclosed, may be, and it is not limited an infrared lamp, hot air, hot stamp, hot die or ultrasonic welding, or any other suitable heat transfer device.

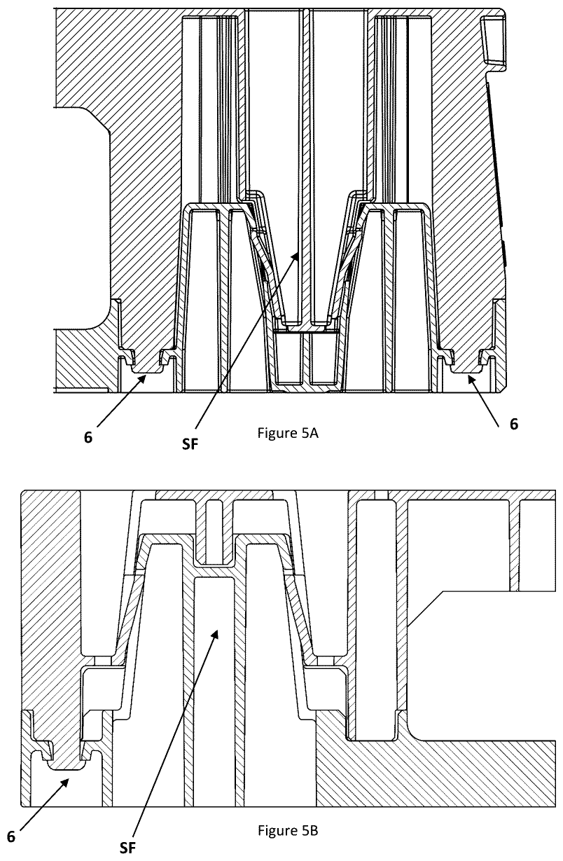

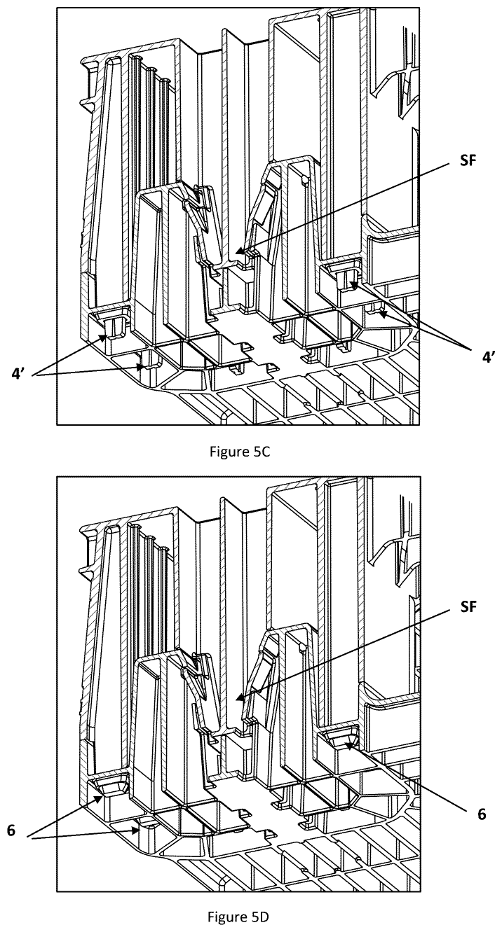

In order to increase clarity of the hot rivet process, the FIGS. 3A and 3B shows how the pre-formed rivet pins pass through the holes (of the lower deck); henceforth, as shown in FIGS. 4A and 5C, a terminal portion of the pre-formed rivet pins protrudes the lower surface of the lower deck and, as shown in FIGS. 4A and 5D, once the hot riveting process is applied to each rivet pin, the protruding terminal portion is deformed, forming a rivet head or a pin head (6) as previously disclosed.

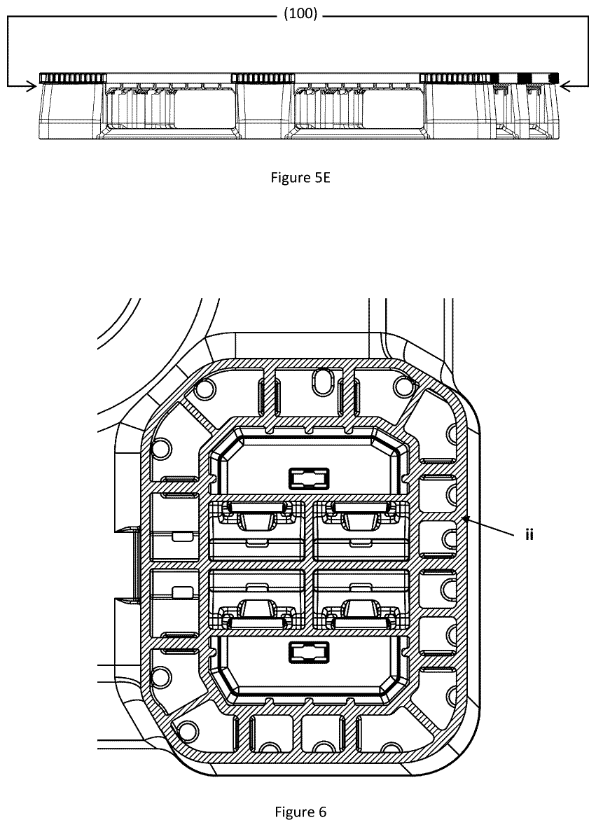

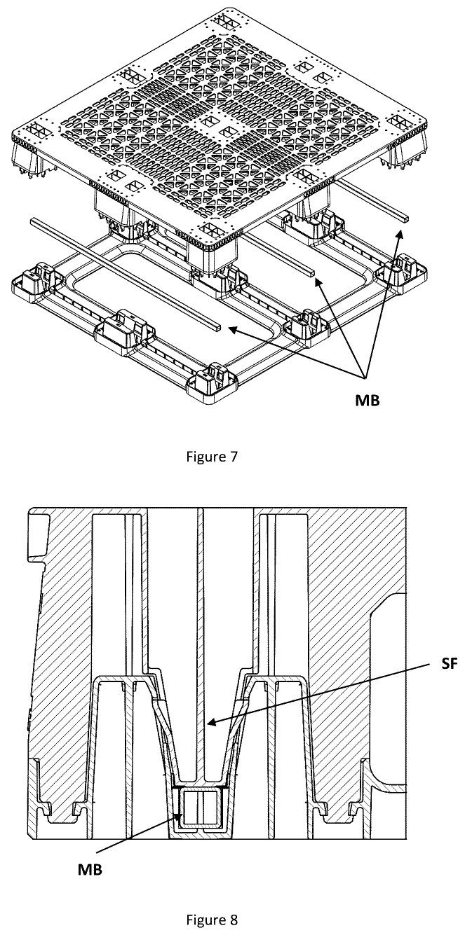

In one embodiment, the pallet of the present invention may comprise from 2 to “n” quantity of preformed rivet pins, disposed in the legs (3) of the pallet. In this sense, the plurality of preformed rivet pins may be disposed in the legs (3) on any kind of arrangement or array and is not limited to an equidistant distributed array as shown in the FIGS. 3A, 3C and 6.

In an additional embodiment, the legs (3) may an improved peripheral grip (100) as seen in FIG. 5E; this improved peripheral grip have a novel design which improves the contact and/or interaction between the pallet and a stretch film.

In a preferred embodiment, the pallet with the joining system of the present disclosure may comprise additional adjusting means (SF); the additional adjusting means (SF) may be any other joining means, which is meant to complement the hot riveting coupling system; Based on the foregoing, said additional adjustment means (SF) will or may be a complementary component that provides additional support, strength, or firmness to the hot riveting coupling system of the joining system. In one embodiment, the pallet of the present invention does not have any additional adjustment means (SF), having only the hot riveting coupling system. In a preferred embodiment, the additional adjustment means (SF) are snap fit coupling means; in other embodiment, the additional adjustment means (SF) or are any other similar or relative mechanical coupling mean, which involves a press fit, or any other mechanical interaction means.

In a further embodiment, and as shown in FIGS. 3A to 5D, an additional adjusting means may be integrated to the legs; in a preferred embodiment, the additional adjusting means are snap-fit connections (i) disposed respectively in each leg of the pallet; as previously stated, this additional adjusting means contribute to the overall mechanical properties of the pallet, since, along with the rivet formed by the hot riveting process, said snap-fit connection (i) may enhance the rigidity and stability of the attachment of both top (1) and bottom (2) decks; each snap-fit member may comprise a head for engaging a corresponding snap-fit member aperture formed in the bottom deck (2).

The snap-fit assembly method, included as an additional adjustment mean in the present invention, is a known mechanical joint involving two coupling components requiring that at least one of said components to be deformed to be hooked or matched one to the other. Based on the above, it is known that snap-fit assembly method presents undesired movement or a certain degrees of movement freedom once the assembly has been performed. This movement freedom of the joint represents an important disadvantage when applying loads on pallets since it accentuates the natural deformation of the pallet when it is handled with a forklift (namely, due to dynamic load) and when it is placed in racking condition, thus, snap-fit joints in pallets tend to fail under impacts and falls typical of the use or application.

In the present invention, the additional adjustment means (SF), and according to the preferred embodiment as previously disclosed, snap-fit joint may be further considered as a pre-assembly means; for “pre-assembly means” should be understand that this additional adjustment means (SF) may be additionally used for handling the pallet during the manufacturing process prior to the hot-rivet joint process; therefore, the snap-fit joint (according to the preferred embodiment of the present invention) may be used to arrange the upper cover and the lower cover, in a temporary coupling or a first coupling step, so as to retain said components in a determined position with respect to each other; advantageously, once both covers are in position, the snap-fit will prevent the displacement or misalignment of said covers; moreover, —since said snap-fit joint from the additional adjustment means (SF) of present invention will prevent displacement or misalignment of top and bottom covers—, the preformed rivet pins, located at the periphery of each legs (as seen in FIGS. 3A, 3C, partially in FIGS. 5C and 5D), can advance to their final position or their position prior to the execution of the hot rivet process, thus facilitating the hot rivet process.

Consequently, the join usage or the combination of both hot rivet formed means and the additional adjustment means (SF), as previously stated, allows to stiffen and stabilize the joint of the top deck with the bottom deck minimizing the deformations present during the loading conditions of the pallet, and consequently, enhancing the overall mechanical properties of the pallet as demonstrated in the Examples of the present application.

Moreover, with the aim of providing greater resistance to the impacts, particularly impact from forklift forks, the present pallet, in a preferred embodiment, may comprise a rib array (ii) within the legs, which may have an internal structure formed by an exterior perimeter, an internal perimeter and a plurality of walls connecting said exterior perimeter with the interior perimeter, as shown in FIG. 6. Nevertheless, said rib array may not be limited by the exterior and interior perimeter configuration as previously disclosed and other arrays may be used, in order to provide greater resistance to the impacts.

In an additional embodiment, the legs of the pallet of present invention may have an internal structure with an array involving other forms; said internal structure may be a plurality of ribs or an array of ribs, connecting each other starting from an common centre, or said plurality or array of ribs may be connected on one side to an internal periphery, and on the other side, to a central wall structure, as shown in the Figures.

A person skilled in the art can ascertain that, for the plurality of ribs or the array of ribs, any kind of arrangement may be used within the legs of the pallet of the present invention, since the essence of said ribs clearly refers to reinforcement means which provides greater resistance to the impacts, particularly impact from forklift forks, so, any other form or arrangement can be included within the scope of current invention, and is not limited to the embodiment illustrated in the Figures or as disclosed within this description.

In a further aspect, the legs (3) are in the centre periphery of the pallet of the present disclosure. Its purpose is to function as supports that create spaces between them, where these spaces allow a forklift or pallet jack to be inserted. These spaces are called fork entries (7). Thus, one of the advantages of the legs (3) is its configuration to avoid separation and/or displacement of the parts caused by the forklift forks or pallet jacks during their insertion into said fork entries.

In another embodiment, the legs (3) further comprises the additional adjustment means (SF), as previously disclosed, which may be match and interact one to each other; as shown in the Figures, the legs (3) of current invention comprises both jack and socket (or a kind of male and female connector) of a snap-fit coupling means, and, as previously disclosed in current application, both jack and socket may hatch one to each other, preventing any kind of displacement between top and bottom deck.

In a preferred embodiment, the snap-fit coupling can be disposed in a lower position configuration as shown in FIGS. 3A, 4A, 5A, 5C and 5D; in this sense, for “disposed in a lower position configuration” it must be understand that the receiving portion (female portion) of the snap-fit portion is located/formed in the lower deck of the pallet, and the male portion of the snap-fit portion is located/formed in the upper deck of the pallet.

In an additional embodiment, the snap-fit coupling can be disposed in an upper position configuration as shown in FIGS. 3B, 4B and 5B; in this sense, for “disposed in an upper position configuration” it must be understand that the receiving portion (female portion) of the snap-fit portion is located/formed in the upper deck of the pallet, and the male portion of the snap-fit portion is located/formed in the lower deck of the pallet.

In another embodiment, the pallet of the present disclosure comprises an improved reinforcement metallic bars system (MB), formed by a plurality of bars disposed, preferably, next to the snap fit coupling of the improved coupling system; in this sense, for “next to” it must be understood as that the improved reinforcement metallic bars system (MB) can be disposed in the vicinity of said snap-fit coupling. As shown in FIG. 8, said improved reinforcement metallic bars system (MB) can be disposed down the snap-fit coupling; or according to the additional embodiment wherein the snap-fit connection is in an upper location configuration, the improved reinforcement metallic bars system (MB) can be disposed over/above the snap fit coupling.

The improved reinforcement metallic bars system (MB) can be from one to “n” number of bars; said improved reinforcement metallic bars system (MB) are metallic bars manufactured with any kind of cross-section area, form or shape; additionally, said improved reinforcement metallic bars system (MB) may be manufactured in any material selected from the group comprising steels or alloys, iron, aluminum, stainless steel, combinations or allows thereby or similar materials with improved mechanical properties, particularly, for bending resistance.

In another embodiment, the pallet of the present disclosure may not comprise the improved reinforcement metallic bars system (MB) previously mentioned.

Many advantages will be apparent for the person skilled in the art in light of the present disclosure, for instance, tensile stress develops within rivets as it cools down. This stress helps gripping components tightly and rivets are subjected to both shear and tensile force when subjected to flexural deformations caused by material handling operations such as dynamic load (fork lift handling) or racking in warehouses, thus avoiding deflections and/or separation of the parts of the present pallets.

Regarding the materials used for the elaboration of the pallet, it should be noted that although thermoplastic materials have been mentioned as a preferent material for manufacturing all of its parts, it is also possible to replace it with another type of materials such as metals, composites materials, organic materials, recyclable materials, and any suitable material for the person skilled in the art.

### EXAMPLES

The following examples show comparative pallet load tests with the joining system of the present disclosure vs. joints known in the prior art.

### Example 1. Physical (Field Test) Bending Test

### Conditions:

Physical testing with pallet samples from pilot production, 3 samples per test.
Compression machine and method based on ISO 8611-1 Second edition 2011 May 15 “Pallets for materials handling-Test methods”
   Machine characteristics:
TECHLAB SYSTEMS Validator-Validator & VAL Series 3 Ton7

### Results:

A) DINAMIC TEST

TABLE 1
Comparative over Dynamic test without hot rivets (prior art) vs.
Inventive combination of hot rivets along side with an additional
adjustment means (SF) (snap fit) (present invention).
DYNAMIC TEST

| | | | | MACHINE LECTURE | |
|---|---|---|---|---|---|
| | | | | Instant | |
| | | | | deflection | 10 minutes |
| | Test | Date | Time | with load | deflection |
| 5.5 | 2.1 | 7 Nov. 2022 | 12:00 p.m. | 18.94 | 25.67 |
| ONLY SNAP FITS | A | | | | |
| | 2.2 | 8 Nov. 2022 | 11:20 a.m. | 18.6 | 25.16 |
| | A | | | | |
| | 2.3 | 8 Nov. 2022 | 01:00 p.m. | 19.7 | 26.7 |
| | A | | | | |
| AVERAGE | | | | 19.08 | 25.84 |
| MEDIAN | | | | 18.94 | 25.67 |
| 5.5 | 1.1 | 7 Nov. 2022 | 11:40 a.m. | 14.67 | 19.4 |
| HOT RIVET + SNAP | A | | | | |
| FITS | 1.2 | 8 Nov. 2022 | 10:30 a.m. | 14.42 | 19.22 |
| | A | | | | |
| | 1.3 | 8 Nov. 2022 | 12:10 p.m. | 14.24 | 18.61 |
| | A | | | | |

| | | |
|---|---|---|
| AVERAGE | 14.44 | 19.08 |
| MEDIAN | 14.42 | 19.22 |

B) RACKING TEST (24 HOUR RACKING TEST)

TABLE 2
Comparative over Racking test without hot rivets (prior art)
vs. Inventive combination of hot rivets along side with an additional
adjustment means (SF) (snap fit) (present invention).

| | 24 HOURS TEST | | | |
|---|---|---|---|---|
| | | | MACHINE LECTURE | |
| | | | Instant | |
| | | | deflection | 1 hour |
| | Test | Date | with load | deflection |
| 5.5 | 1.1 | 2 Nov. 2022 | 5.18 | 13.55 |
| HOT RIVET + SNAP | C | | | |
| FITS | 1.2 | 22 Nov. 2022 | 5.31 | 13.1 |
| | C | | | |
| | 1.3 | 29 Nov. 2022 | 5.26 | 12.71 |
| | D | | | |
| | AVERAGE | | 5.25 | 13.12 |
| | MEDIAN | | 5.26 | 13.10 |
| 5.5 | 2.1 | 17 Nov. 2022 | 6.01 | 14.69 |
| ONLY SNAP FITS | C | | | |
| | 2.2 | 21 Nov. 2022 | 6.15 | 14.62 |
| | C | | | |
| | 2.3 | 29 Nov. 2022 | 6.83 | 15.74 |
| | D | | | |

| | | |
|---|---|---|
| AVERAGE | 6.33 | 15.02 |
| MEDIAN | 6.15 | 14.69 |

### Example 2. Finite Elements Analysis (FEA)

Finite Element Analysis (Computed-Aided simulation) simulating the deformations when a pallet is handle by a forklift (dynamic load analysis) and the placement of a pallet over a two edge rack as used in warehouses (racking load analysis).

### Conditions:

### C) Dynamic Load Analysis

Material: High Density Polyethylene, 900 MPa elastic modulus. 22 MPa yield strength
Load: 1400 kg evenly distributed
Rigid forklift tines, 611 mm between inner edges
Local interactions between parts

### D) Racking Load Analysis

Material: High Density Polyethylene, 900 MPa elastic modulus. 22 MPa yield strength
Load: 900 kg evenly distributed
Rigid rack supports, 1000 mm between inner edges
Local interactions between parts

TABLE 3
Comparative over Dynamic test without hot rivets (prior art) vs. Inventive
combination of hot rivets alongside with an additional adjustment means
(SF) (snap fit) (present invention) for the FEA analysis.

| | | Maximum | Maximum |
|---|---|---|---|
| | Technology | Stress | Displacement |
| Test | Variation | [MPa] | [mm] |
| Dynamic (forklift) | Only snaps | 14.66 | 9.83 |
| Long side | Hot rivet | 12.83 (−12.5%) | 8.01 (−18.5%) |
| | | Maximum | Maximum |
| | Technology | Sress | Sress |
| | Variation | [MPa] | [MPa] |
| Racking | Only snaps | 37.93 | 26.65 |
| Short side | Hot rivet | 16.9 (−55%) | 18.95 (−28.9%) |

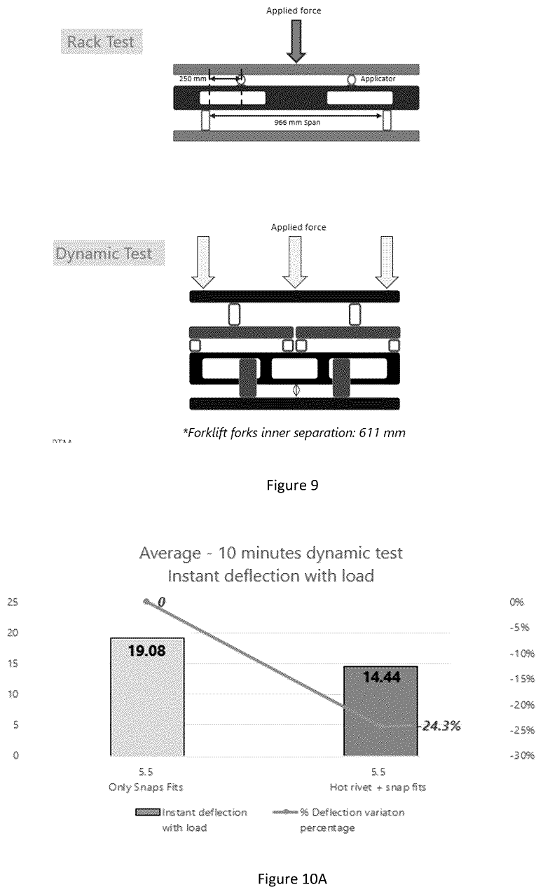

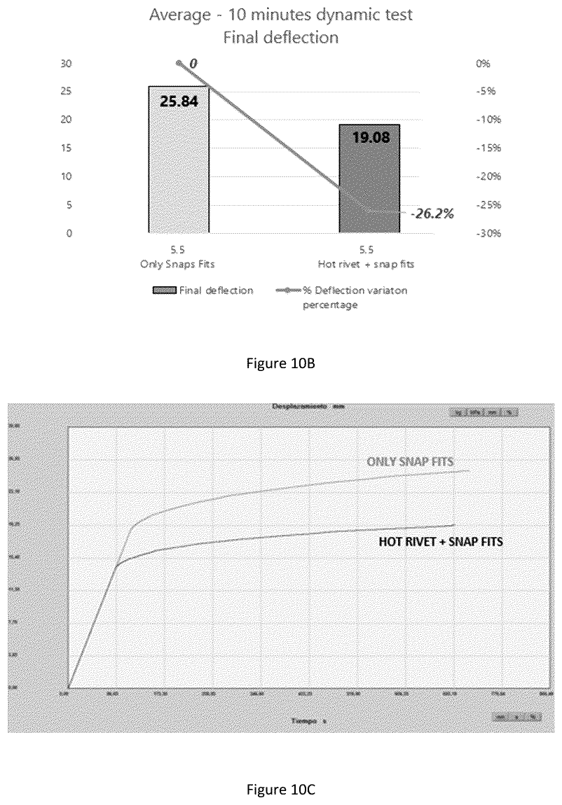

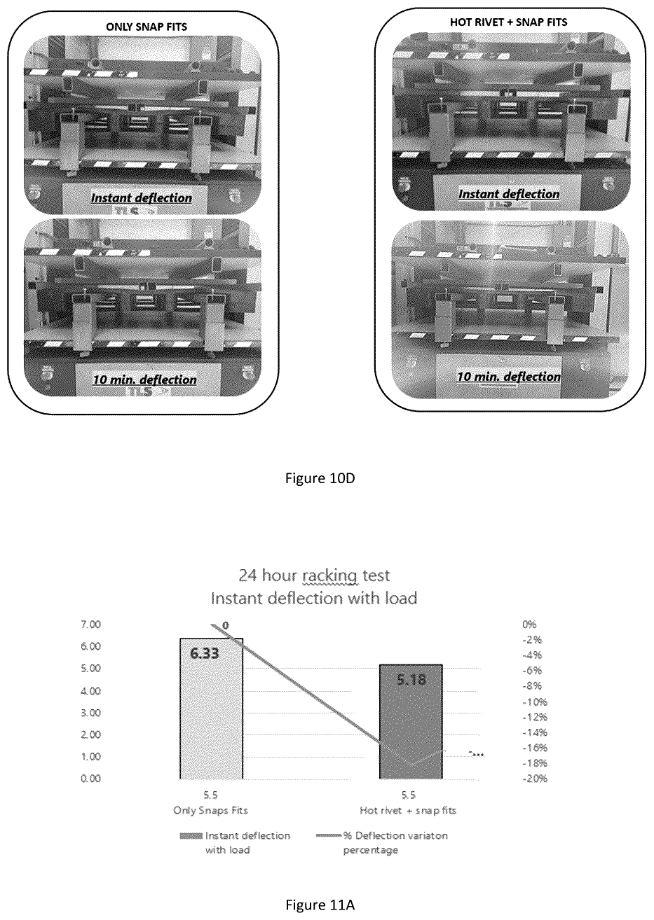

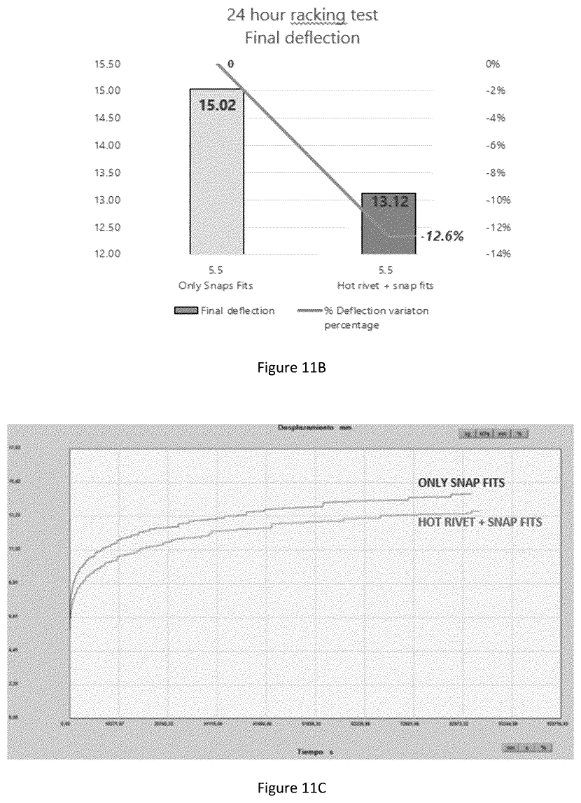

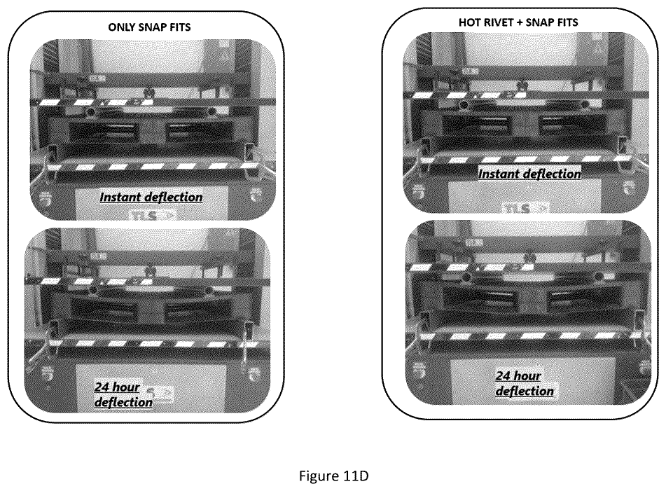

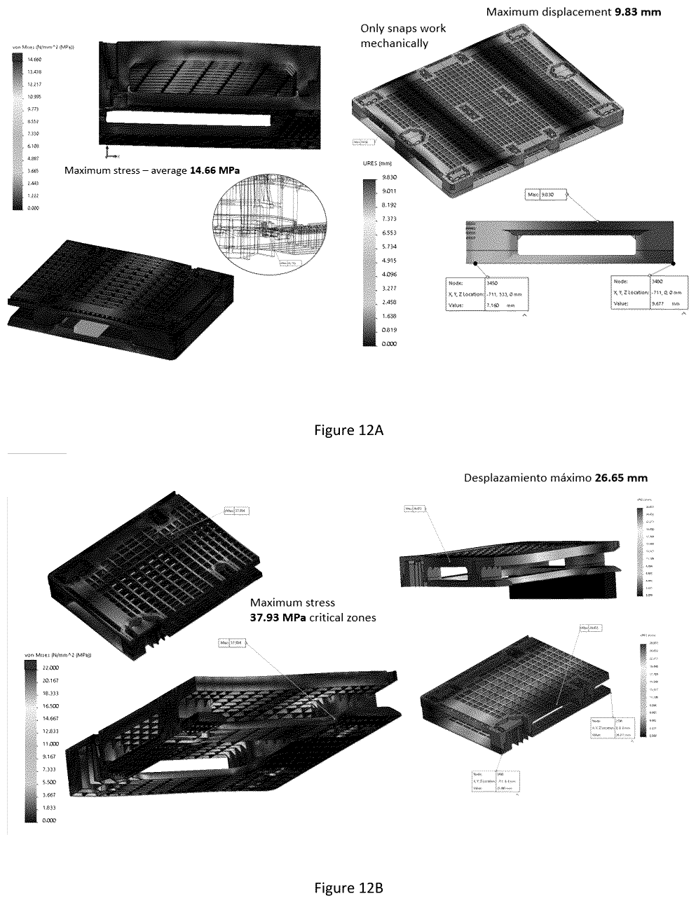

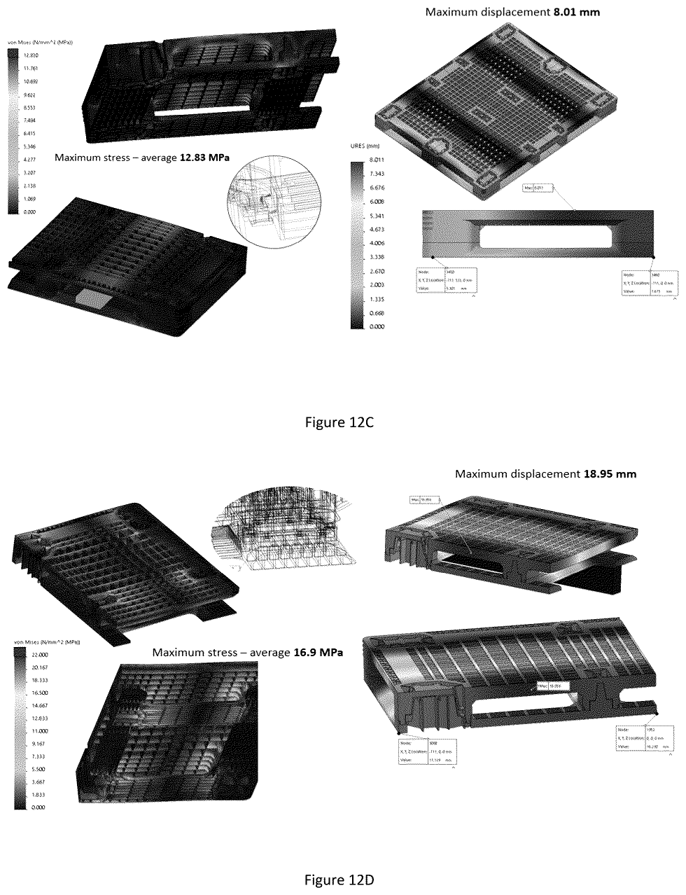

As can be clearly appreciated in FIGS. 9 to 12D, so as in the previously shown tables, the mechanical system of present invention, namely, hot riveting of a plurality of pre-formed rivet pins integrally formed in the top deck leg, once said plurality of pre-formed rivet pin passes through a hole located in the bottom deck leg, combined with an additional adjusting means (in this embodiment, a snap-fit system), advantageously decreases the displacement in both racking and dynamic force application, thus, a person with regular skills of the subject-matter can note that this novel combination of coupling means of the present invention does provide a coupling system that provide enhanced mechanical properties.

1. A plastic pallet comprising:
a top deck, which is in turn formed by an upper face, a lower face, a left side face, a right-side face, a front face, and a rear face, wherein the lower face includes a plurality of legs integrally formed thereof, and wherein said plurality of legs are at least one upper part of leg, as well as a plurality of crossed and simple ribs;
a bottom deck, which is in turn formed by an upper face, a lower face, a left side face, a right-side face, a front face and a rear face, wherein the upper face includes a plurality of legs integrally formed thereof, and wherein said plurality of legs are at least one lower part of leg, as well as a plurality of crossed ribs, a plurality of simple ribs and a plurality of fork entries;
wherein the joining or coupling between the lower face of the top deck with the upper face of the bottom deck, occur when the lower part of leg of the bottom deck overlap with the upper part of leg of each leg of the plurality of legs, forming a plurality of spaced apart, entirely formed, legs corresponding to each leg of the plurality of legs;
when said upper and bottom deck are overlapped, a plurality of joining members integrally formed in the top deck legs pass through a corresponding plurality of holes disposed in the bottom deck legs; once the plurality of joining members passes through the corresponding plurality of holes, the joining members comprise a distal end portion or pin head protruding from the lower portion of the holes,
the joining members exactly match in number and array with the holes in the lower part of the leg; the joining members having such a length that after the top deck and bottom deck are fully coupled, the distal end portion or pin head protrudes from the corresponding opposite portion, thus, said pin head shall be shall be heated to form a dome, plate, disk, semi-sphere, and related shapes and carrying out a hot riveting process of the pin head; and
wherein the plastic pallet further comprises additional adjusting means.

2. The plastic pallet according to claim 1, wherein the joining members are integrally formed with the top deck, and the material of which said joining members are made of is deformable by heat or has adequate properties to allow the transformation throw heat deformation of the distal end portion of each joining members.

3. The plastic pallet according to claim 2, wherein the joining members are pre-formed pins, rods, stakes and/or shanks, or any suitable piece.

4. The plastic pallet according to claim 1, wherein the crossed ribs in the top deck coincide with the crossed ribs of the bottom deck to provide enhance resistance to bending when the top and bottom are joined or the crossed ribs in the top deck do not necessarily coincide or match with said crossed ribs of the bottom deck

5. The plastic pallet according to claim 1, wherein the legs may be entirely formed in the top deck or the bottom deck, or any known combination.

6. The plastic pallet according to claim 1, wherein the plurality of joining members can be formed in the bottom deck and the plurality of holes in the top deck, or in an alternate arrangement.

7. The plastic pallet according to claim 1, wherein the joining members are made of the same material as the top and bottom deck of the pallet.

8. The plastic pallet according to claim 1, wherein the additional adjusting means are snap-fit connections disposed respectively in each leg of the pallet; wherein along with the rivet formed by the hot riveting process, said snap-fit connection enhances the rigidity and stability of the attachment of both top and bottom decks; each snap-fit member comprising a head for engaging a corresponding snap-fit member aperture formed in the bottom deck.

9. The plastic pallet according to claim 1, wherein the legs comprise a rib array having an internal structure formed by an exterior perimeter, an internal perimeter and a plurality of walls connecting said exterior perimeter with the interior perimeter.

10. The plastic pallet according to claim 1, wherein the legs further comprise the additional adjustment means, which match and interact one to each other; the legs comprise both jack and socket of a snap-fit coupling means, and both jack and socket hatch one to each other, preventing any kind of displacement between top and bottom deck.

11. The plastic pallet according to claim 10, wherein the pallet comprises an improved reinforcement metallic bars system, formed by a plurality of bars disposed, next to the snap-fit coupling; and wherein the improved reinforcement metallic bars system can be disposed in the vicinity of said snap-fit coupling; or down the snap-fit coupling.

12. The plastic pallet according to claim 1, wherein the pallet comprises from 2 to “n” quantity of preformed rivet pins, disposed in the legs of the pallet; the plurality of preformed rivet pins may be disposed in the legs on any kind of arrangement or array not limited to an equidistant distributed array.

13. A method for carrying out the hot riveting process of a pin head of claim 1, comprising the steps of:
bringing the pin head to an optimum temperature, wherein the plastic material of said preformed rivet pins can be deformed; said optimum temperature is constantly applied by heat supply from an adequate heat source and forming a rivet head or a pin head with a die integrally formed with the heat source in a quickly and stably manner;
as soon as the pin head has reached the required temperature for modifying its form, a preset pressure is applied to said preformed rivet pin, until said pin head is modified producing a rivet head or a pin head.
cooling the joining system may be cooled down to preserve and strengthen the new formed rivet head.

14. The method according to claim 13, wherein the heat source which applies constant heat to the preformed rivet pin, is selected from an infrared lamp, hot air, hot stamp, hot die or ultrasonic welding, or any other suitable heat transfer device.

15. The plastic pallet according to claim 7, wherein the material comprises HDPE or polypropylene.

16. The plastic pallet according to claim 10, wherein the pallet comprises an improved reinforcement metallic bars system, formed by a plurality of bars disposed next to the snap-fit coupling, and wherein the snap-fit connection is in an upper location configuration and the improved reinforcement metallic bars system can be disposed over/above the snap-fit coupling.
